(19) United States
(12) Patent Application Publication
(10) Pub. No.: US 2004/0060603 A1
(43) Pub. Date: Apr. 1, 2004

(54) Automatic valve device

(76) Inventor: Kil Bong Song, Youngdungpo-Ku, Seoul (KR)

Correspondence Address: David A Kalow, Kalow & Springut, 19th Floor, 488 Madison Avenue, New York, NY, 10022, US

(21) Appl. No.: 10/312,747

(22) PCT Filed: May 30, 2001
(86) PCT No.: PCT/KR01/00911

(30) Foreign Application Priority Data
Jun. 9, 2000 (KR) 2000/31731

(51) Int. Cl. F16K 37/00

(52) U.S. Cl. 137/554

(57) ABSTRACT

Disclosed is a valve device having a valve case (100) acting as a sealing means for sealing a line connection section such as a pipe or hose for passing fluid therethrough. The valve device includes flow detecting section (110), provided in the valve case, for acting as a flow sensor in response to pressure according to the flow rate, the flow detecting section having a rotary wing (111) being rotated by the pressure of the flowing fluid to open/close a passage; a flow locking section (120), provided on a lower portion of the flow detecting section, for acting as a check valve-typed valve body (121) for controlling the flow rate in the valve case as a plate-shaped valve main body rotates on a hinge; a displacement detecting section (130) for detecting rotation of the rotary wing of the flow detecting section and rotation of the check valve-typed valve main body of the flow locking section; and a restoring section (143, 143a, 141a, 141b) for producing an alternate magnetic force to operate and restore the flow detecting section (190) and the flow locking section (120).

### BACKGROUND OF THE INVENTION

1. Field of the Invention

The present invention relates to an automatic valve device, and more particularly to a small-sized automatic valve of a magneto-sensitive type.

2. Description of the Related Art

A valve that permits or cuts off the flow of fluid passing through a pipe has a structure wherein an internal passage is formed through a valve seat in a valve case interposed in the pipe having a predetermined diameter as a sealing means, and the passage is open or closed by rotation of a valve coke provided with a ball valve.

According to this mechanical valve device, the flow rate of fluid or gas that flows inside the pipe and the valve case is varied by increasing or decreasing the opening degree of the pipe in proportion to the amount of rotation of the valve coke.

In the mechanical valve device, the opening degree of the pipe is increased or decreased by a motor for automatically rotating the valve coke, and this causes the disadvantages that the on/off state of the valve should be directly confirmed.

Also, no means for controlling the flow of fluid or gas in the pipe is used, and thus it is impossible to confirm the quantity of flow in the pipe. Accordingly, in order to control an excessive flow, it is recognized only in dependence on the user's intuition, and then the valve coke is manipulated by the user.

Further, according to the conventional valve structure, the valve coke is connected to the two pipes by a turnbuckle or serration, and thus the sealing state of the joint of the valve coke and the pipe should be continuously confirmed. Although the design of the manual valve device has been improved, there has been a continuous demand for the much greater sealing performance. Also, in manufacturing the valve device, there has been a demand for the much greater decrease of the complexity of the valve structure without deteriorating the reliability.

### SUMMARY OF THE INVENTION

Therefore, an object of the invention is to solve the problems involved in the related art, and to provide an automatic valve that enables easy grasping of the opening/closing of the valve and the flow state of fluid passing through a pipe, and controls the quantity of flow in the pipe effectively.

In order to achieve the above object, the present invention provides a valve device having a valve case acting as a sealing means for sealing a line connection means such as a pipe or hose for passing fluid therethrough, the valve device comprising a flow detecting means, provided in the valve case, for acting as a flow sensor in response to a pressure according to the flow of the fluid to detect the flow of the fluid, the flow detecting means having a rotary wing for rotating by the pressure of the flowing fluid to open/close a passage; a flow locking means, provided on a lower portion of the flow detecting means, for acting as a check valve-typed valve body for controlling a quantity of flow in the valve case as a plate-shaped valve main body rotates on a hinge; a displacement detecting means for detecting rotation of the rotary wing of the flow detecting means and rotation of the check valve-typed valve main body of the flow locking means; and a restoring means for producing an alternate magnetic force to operate and restore the flow detecting means and the flow locking means.

### BRIEF DESCRIPTION OF THE DRAWINGS

The above object, and other features and advantages of the present invention will become more apparent after a reading of the following detailed description when taken in conjunction with the drawings, in which:

FIG. 1 is a side sectional view illustrating the construction of an automatic valve according to the present invention;

FIG. 2 is an exploded side view of the automatic valve according to the present invention;

FIG. 3 is an exploded side view of a driving means that is separated from the structure of FIG. 2;

FIGS. 4a and 4b are views illustrating the open/close state of a flow locking means, respectively;

FIG. 5 is an enlarged view schematically illustrating the flow locking means according to the present invention;

FIG. 6 is an exploded perspective view of a flow detecting means according to the present invention;

FIGS. 7a to 7d are views illustrating the operating state of the flow detecting means in accordance with the quantity of fluid passing through the automatic valve according to the present invention; and

FIG. 8 is a block diagram of a control circuit for controlling the sensing operation of the automatic valve according to the present invention.

### DETAILED DESCRIPTION OF THE PREFERRED EMBODIMENT

Hereinafter, an automatic valve according to the present invention will be described with respect to a preferred embodiment illustrated in the annexed drawings.

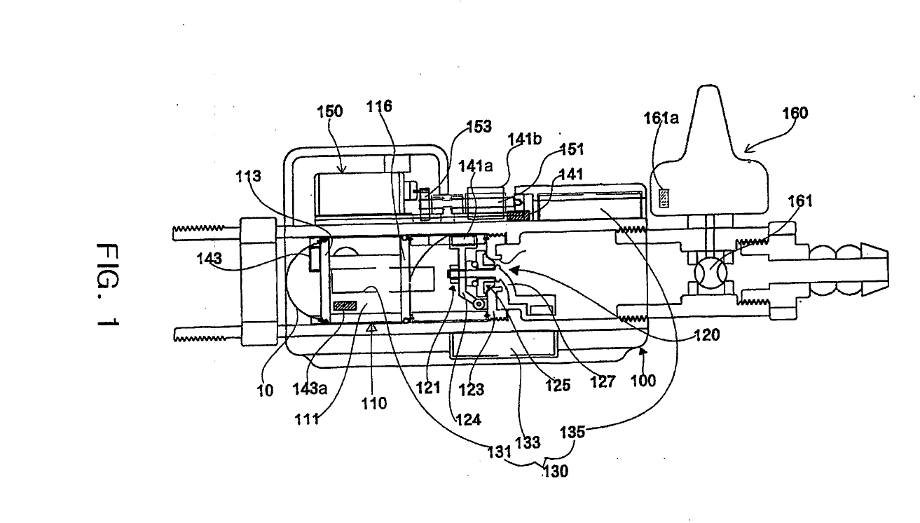

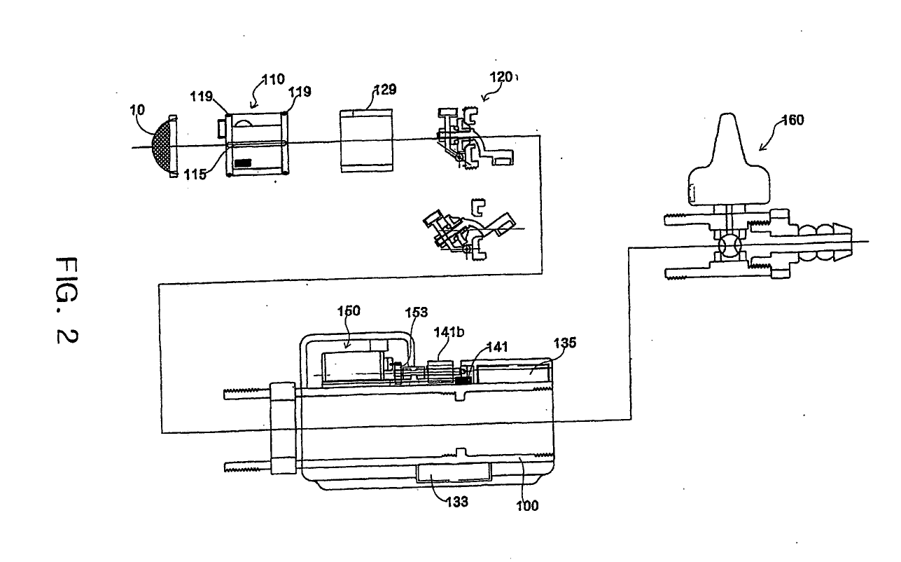

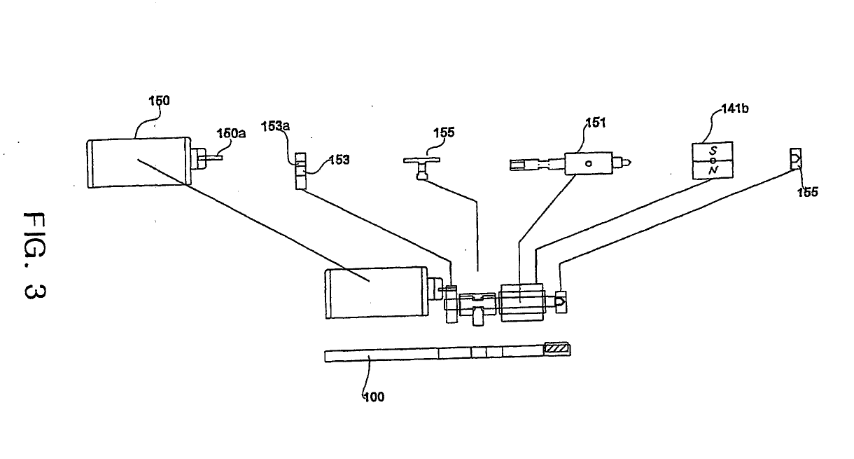

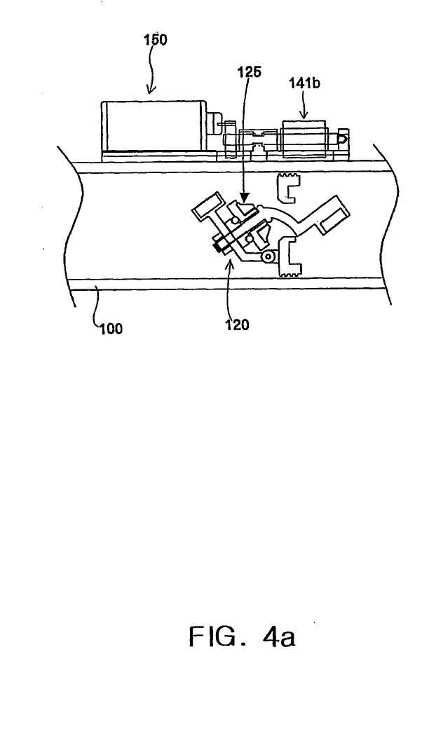

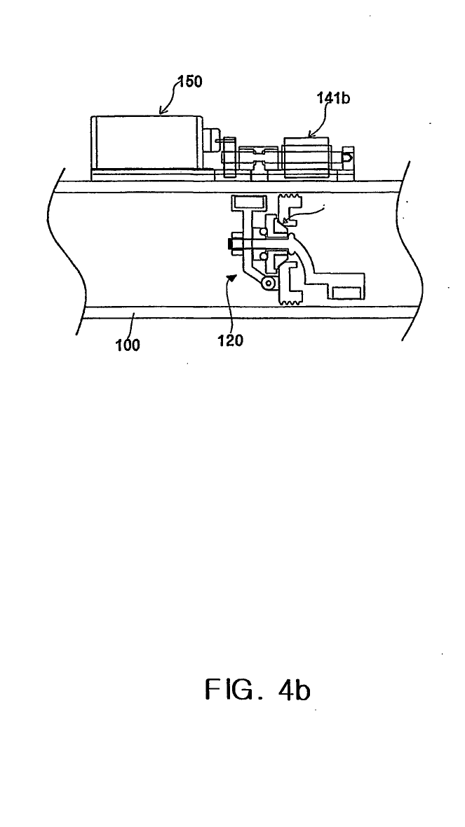

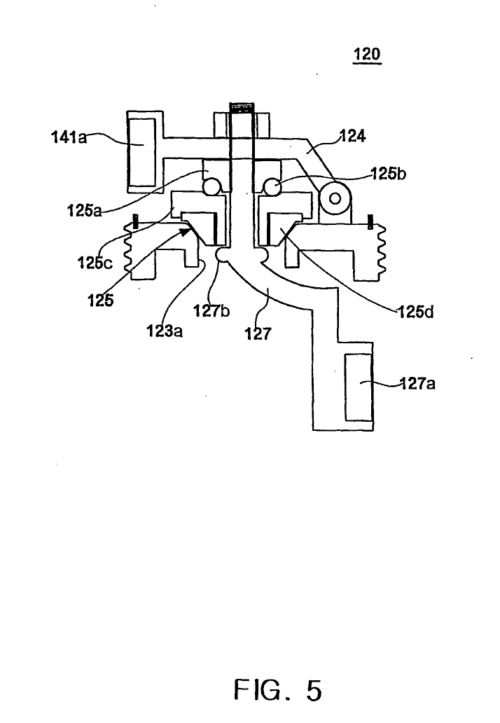

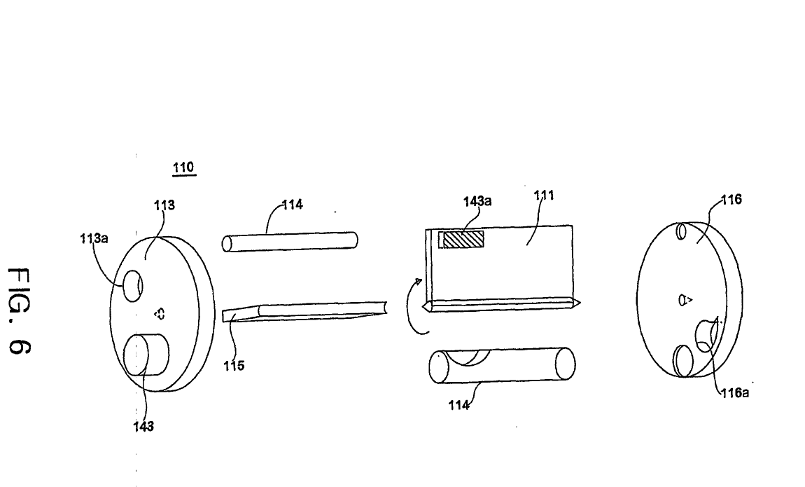

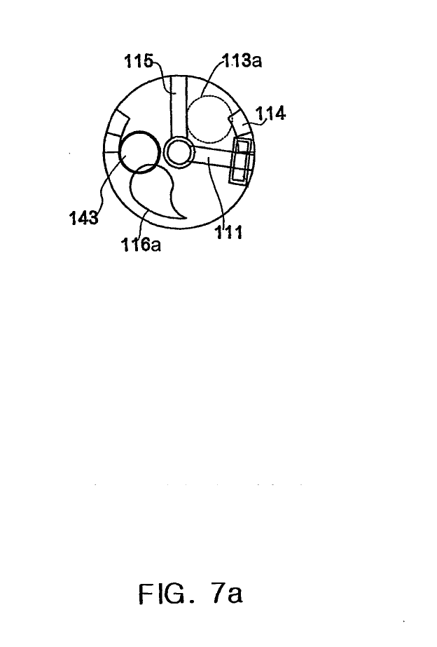

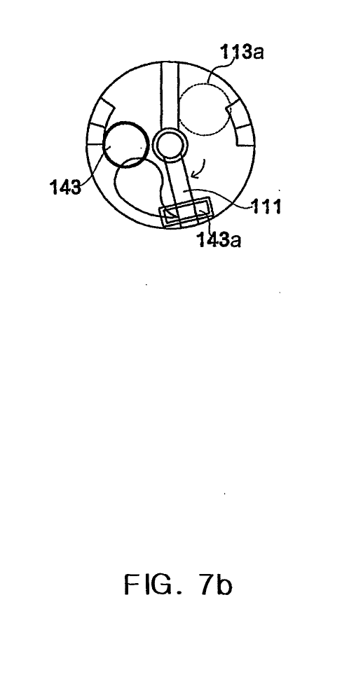

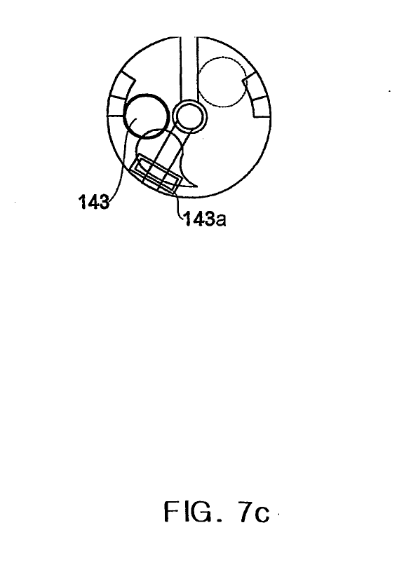

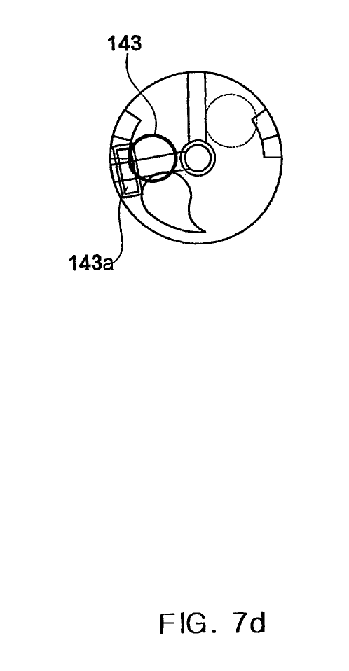

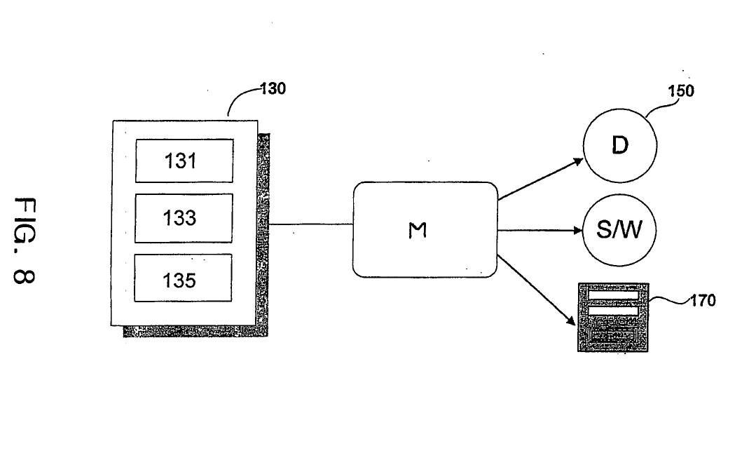

The automatic valve according to the present invention, as shown in FIGS. 1 to 8, is provided with a valve case 100 acting as a sealing means interposed in a line connection section (not illustrated) such as a pipe or hose having a predetermined diameter for passing the fluid to control the flow of the fluid. The automatic valve includes a flow detecting section 110, provided inside the valve case 100, for detecting the flow of the fluid, acting as a flow sensor in response to a pressure according to the flow of the fluid to detect the flow of the fluid, a flow locking section 120, provided on a lower course of the flow detecting section 110, for cutting off the flow of fluid by magnetism if the fluid flow excessively, a displacement detecting section 130 for detecting the operation state of flow detecting section 110 and the flow locking section 120, and a restoring section 140 for operating and restoring the flow detecting section 110 and the displacement detecting section 130.

The automatic valve according to the present invention is mounted on the line connection section such as the pipe or hose passing the fluid therethrough, and is provided with the valve case 100 acting as a section for sealing the line connection section.

In the valve case 100 are provided the flow detecting section 110 which acts as a flow sensor in response to a pressure according to the flow of the fluid to detect the flow of the fluid, and which has a rotary wing 111 for rotating by the pressure of the flowing fluid to open/close a passage; the flow locking section 120, provided on a lower portion of the flow detecting section 110, for acting as a check valve-typed valve body 121 for controlling the quantity of flow in the valve case 100 as a plate-shaped valve main body rotates on a hinge; the displacement detecting section 120 for detecting rotation of the rotary wing 111 of the flow detecting section 110 and rotation of the check valve-typed valve main body 121 of the flow locking section 120; and the restoring section 140 for producing an alternate magnetic force to operate and restore the flow detecting section 110 and the flow locking section 120.

The flow detecting section 110 includes a first fixing plate 113 concentrically arranged with an inner surface of the valve case 100 and having an inlet port 113a on one side thereof, a second fixing plate 116 secured to the first fixing plate through a number of fixing columns 114 and having an outlet port 116a on the other side, a rotary wing 111 rotatably around a shaft which is an imaginary line connecting a center of the first fixing plate 113 and a center of the second fixing plate 116, a rotary magnet 143a, fixed on the rotary wing 111, for generating a magnetic force to be restored by the restoring section 140, and a fixing partition 115 forming a desired space in the valve case together with the inner wall of the valve case 100 and the ratable wing 111. With the construction, the flow detecting section may be rotated due to the fluid flow.

The flow locking section 120 includes a third fixing plate 123 threaded into the inner wall of the valve case 100 and being spaced apart at a constant distance from the rotary wing 111 via a cylindrical body 129, a check valve-typed valve body 121 having a shielding member 125 for shielding or opening a fluid flowing from the outlet port 116a of the second fixing plate 116 to a discharging port 123a of the second plate 123, and a follower 127 with a magnet 127a for the follower secured to one end of thereof. The shielding member 125 has a cover coming and going to the outlet port 116a via the supporting member 124, and a valve body magnet 141a mounted onto one end of the supporting member 124. The supporting member 124 has an outer end pivotally supported onto one side of the third fixing plate 123. The follower 127 has the other end secured to a center of the cover of the shielding member 125.

The restoring section 140 includes an alternate magnetic force producing magnet reacting magnet 141 secured to an outside of the valve case 100 for reacting with the valve body magnet 141a, a rotating body reacting magnet 143 secured to the outside of the valve case 100 for reacting with the rotating body magnet 143a secured at a constant distance from the inlet port 113a of the flow detecting section 110, an alternate magnetic force producing magnet 141b for producing an alternate magnetic force to operate and restore the magnet 141a of the check valve-typed valve body 121, and driving section 150 for rotating the magnet 141b by a half, with the magnet 141b rotatably supported on the outside of the valve case 100.

The driving section 150 includes a rotating shaft 151 rotatably supporting the magnet 141b and intermittently securing the magnet 141b, a rotation stopping plate 153 secured onto one end of the rotating shaft 151, and a solenoid intermittently inserted into the offset hole 153a formed on the plate 153.

The displacement detecting section 130 includes a rotating body detecting sensor 131, secured to the outside of the valve case 100, for detecting the displacement of the magnet 143a of the flow detecting section 110, and a follower detecting sensor 133, secured to the outside of the valve case 100, for detecting the displacement of the magnet 127a of the flow detecting section 110.

The flow locking section 120 may include a valve cock 160, engaged to a downstream end of the check valve-typed valve body 121, for shielding and opening the passage of the fluid, separate with the check valve-typed valve body 121.

The displacement detecting section 130 includes a valve cock detecting sensor 135, secured to the outside of the valve case 100, for detecting the displacement of a valve cock magnet secured to a handle of the valve cock 160.

In addition, preferably the displacement detecting section 130 comprises a non-contact adjacent sensor.

The shielding member 125 of the check valve-typed valved body 121 is floated between the follower 127 secured to a center of the supporting member 124 and a locking protrusion 127b formed on an upper portion of the follower 127.

The shielding member 125 includes a fixed block 125a and a movable block 125c, which are interposed between the blocking protrusion of the follower and the supporting member 124. A seal ring 125b is interposed between the fixed and movable blocks. A sealant 125d made of synthetic resin (Teflon) or rubber is attached to a bottom surface of the movable block 125c.

The shielding member 125 is supported in such a way that it may roll on the follower 127.

The outlet port 116a of the flow detecting means 110 has a structure in such a way that a discharging amount is gradually increased according to the increased rotating angle of the rotating shaft 151.

The valve cock detecting sensor 135, the rotating body detecting sensor 131, and the follower detecting sensor 133 are operated by the magnetic force of each magnet 143a and 127a, and transfers signals produced due to the detecting operating a control box 170 including driving section 150, a switch 160, and a display.

The outer peripheries of the first, second and third fixing plates are sealed with the inner wall of the valve case via a seal-ring (O-ring).

A strainer 10 is installed on the inner wall of the valve case 100 at an upstream end of the flow detecting section 110, to limit the inflow of the alien substance.

Reference numeral 155 indicates a number of shaft bases for supporting the rotating shaft of the magnet 141b, and reference numeral 119 indicates a ring member for improving a seal state between the valve case 100 and the first and second fixing plates 113 and 116.

The operation and effect of the present invention will bow be described.

If the handle of the valve cock 160 is rotated by a predetermined angle, the ball valve 161 is rotated to open the passage. The fluid flows through the inlet port 113a of the first fixing plate 113, and is enclosed by the rotary wing 111 and the partition 115 to produce a constant pressure. At that time, the pressure at the downstream end of the second fixing plate 116 is reduced by the open of the ball valve, so that a pressure difference is produced based on the second fixing plate 116.

If the fluid continuously flows through the inlet port 113a, the pressure difference is gradually increased. The pressure in the space defined by the partition 115, the valve case 110, and the rotary wing is increased, thereby rotating the wing.

At that time, if the wing 111 rotates, the outlet port 116a of the second fixing plate 116 is opened, so that the fluid flows towards the flow locking section.

In addition, if the user rotates the magnet for generating an alternate magnetic force of the restoring section 140, the shielding member 125 of the flow locking section 120 is rotated by the repulsive force of the valve body magnet 114a against the alternate magnetic force producing magnet thereby opening the outlet port 123a of the third fixing plate 123.

In order words, upon flowing the fluid by the user, the valve cock detecting sensor is operated by the magnetic force of the valve cock magnet, and transfers a signal for opening the valve cock. The rotating body detecting sensor is operated by the displacement of the magnet 143a of the rotary wing, and transfers a signal for opening the outlet port 116a of the second fixing plate 116. And, if the magnet 127a of the flow locking section 120 is moved from the follower detecting sensor 133, the sensor 133 detects the state, and transfers a signal for opening the discharging port 123a of the third fixing plate.

The operation of opening the shielding member 125 of the flow locking section 120 against the discharge port 123a of the third fixing plate 123 is performed by the signal for opening the shielding member 125 from the microcomputer, or the repulsive force produced by the same polarity of the magnet 141a and the magnet 141b.

At that time, the display shows a state allowing the fluid to flow.

Accordingly, since the user can recognize the state of the fluid displayed on the display of the control box 170, there is no dangerous in that no the user turns off a valve of gas.

The operation of turning off the flow is performed with attracting the magnet 141a by the magnetic force of the alternate magnetic force producing magnet 141b. Specifically, the polarity of the magnet 141b is faced to the opposed polarity of the magnet 141a by rotating the magnet 141b by hand or the motor, so that the gas flowing state is converted into the gas flow limiting state.

The conversion of the gas flow state may be performed by the solenoid. Specifically, the conversion is performed by the rotating shaft 151 of the alternate magnetic force producing magnet 141b, the rotation limiting plate 153 engaged to the rotating shaft 151, the solenoid having a plunger 150a, and received into a restraining hole of the plate, 153 for restraining the movement of the plate 153, and the polarity of the magnet 141.

In order words, the user allows the magnet 141b to rotate, so that the polarity (S) of the magnet 141 is opposed to the polarity (S) of the magnet 141b. At the peak point of the repulsive force, the plunger 150a of the solenoid is received into the restraining hole of the plate 153 engaged to the magnet 141b via the rotating shaft 151, thereby restraining the rotation.

At that timer with the magnet 141b applying the repulsive force to the magnet 141a, the shielding member 125 is rotated away from the discharging port 123a, thereby opening the passage.

In case that the user gets ready to go out while the passage of the gas is maintained in an open state, the user manipulates the solenoid operating switch to transfer the signal for operating the solenoid. If the plunger of the solenoid is released from the restraining hole of the plate 153 the magnet 141b is rotated by the repulsive force of the magnet 141, and the valve magnet is attracted to the magnet 141b. And then, the shielding member 125 is rotated towards the discharging port, thereby closing the discharging port 123a and preventing further flow of the gas.

At that time, while the follower 127 of the shielding member is rotated to its original position, the magnet 127a detects the adjacent position by the sensor 133. The detected signal is transferred to the microcomputer, and then the display shows that the discharging port 123a is closed by the shielding member 125.

In addition, in order to provide the gas flow with a double safety lock, if the valve cock 160 is rotated towards the closing direction, the adjacent displacement signals from the valve cock magnet and the valve cock detecting sensor 135 is transferred to the microcomputer, and the microcomputer operates to display the marks showing the fully closed state on the display.

The flow rate of the fluid can be detected by the rotating body detecting sensor for detecting an angular displacement of the rotting wing 111 which is variably rotated depending upon the flow rate of the fluid.

The rotary wing 111 is rotated to its original position by the same polarity magnetic force of the magnet 143, if the pressure difference of the fluid is disappeared by the locking operation of the gas flow.

In addition, if the flow rate of the fluid passing through the discharging port 123a of the third fixing plate 123 is higher than the predetermined valve, the supporting member 124 and the shielding member 125 are closed with being swept by the flow. At that time, the adjacent position signal of the magnet 127a is transferred to the microcomputer, the microcomputer determines that the overflow is happened, and operates the driving section 150 such as a solenoid and a driving motor. The microcomputer operates the shielding member 125 to control the discharging port 123a, and the mechanical locking state is converted into the electric/electronic locking state.

At that time, the magnetic force sensitive degree is varied by changing the repulsive distance of the magnet 141a due to the left and right movement of the magnet 141b, thereby controlling the flow rate of the fluid by changing the opened degree of the valve.

As described above, it is possible to recognize at an another area whether the valve of the gas is closed or not. Also, the flow rate of the gas passing through the valve is exactly monitored. If the overflow of the gas is passed through the valve, the flow is automatically shut down. The operating state of the valve is electrically converted.

The present invention may be employed into any sites, since the construction is simple.

In particular, if the present invention is employed into a gas piping, the auto shut is possible. If an accident is happened, the auto shut is automatically performed, and an alarm signal is produced.

Although the preferred embodiment of the present invention has been disclosed for illustrative proposes, those skilled in the art will appreciate that various modifications, additions and substitutions are possible, without departing from the scope and spirit of the invention as disclosed in the accompanying claims.

What is claimed is:

1. A valve device having a valve case acting as a sealing means for sealing line connection means such as a pipe or hose for passing fluid therethrough, the valve device comprising:
flow detecting means, provided in the valve case, for acting as a flow sensor in response to a pressure according to a flow rate of the fluid to detect the flow of the fluid, the flow detecting means having a rotary wing for rotating by the pressure of the flowing fluid to open/close a passage;
wherein, the rotary wing is rotatably supported on a center line longitudinally taken along the line connection means.

2. An auto valve having a valve case acting as a sealing means for sealing line connection means such as a pipe or hose for passing fluid therethrough, the valve device comprising:
flow locking means, provided in the valve case, for acting as a check valve-typed valve body in response to a pressure according to the flow of the fluid to control a flow rate of the fluid;
displacement detecting means for detecting rotation of the check valve-typed valve body of the flow locking means 120; and
restoring means for producing an alternate magnetic force to operate and restore the flow locking means and the check valve-typed valve body.

3. The valve as claimed in claim 1 or 2, further comprising an alternate magnetic force producing magnet, rotatable supported on an outside of the valve case, for producing an alternate magnetic force to operate and restore the magnet of the check valve-typed valve body, and driving means for rotating the magnet by a half, with the magnet rotatably supported on the outside of the valve case.

4. The valve as claimed in claim 3, further comprising an alternate magnetic force producing magnet reacting magnet, secured to the outside of the valve case, for reacting with the valve body magnet fixed on the check valve-typed valve body.

5. A valve device having a valve case acting as a sealing means for sealing line connection means such as a pipe or hose for passing fluid therethrough, the valve device comprising:
flow detecting means, provided in the valve case, for acting as a flow sensor in response to a pressure according to the flow of the fluid to detect the flow of the fluid, the flow detecting means having a rotary wing 111 for rotating by the pressure of the flowing fluid to open/close a passage;
flow locking means, provided on a lower portion of the flow detecting means, for acting as a check valve-typed valve body for controlling a flow rate in the valve case as a plate-shaped valve main body rotates on a hinge;
displacement detecting means for detecting rotation of the rotary wing of the flow detecting means and rotation of the check valve-typed valve main body of the flow locking means; and
restoring means for producing an alternate magnetic force to operate and restore the flow detecting means and the flow locking means.

6. The valve as claimed in claim 5, wherein the flow detecting means includes a first fixing plate concentrically arranged with an inner surface of the valve case and having an inlet port on one side thereof, a second fixing plate secured to the first fixing plate through a number of fixing columns and having an outlet port on the other side, a rotary wing rotatably supported around a shaft which is imaginary line connecting a center of the first fixing plate and a center of the second fixing plate, and a rotary magnet, fixed on the rotary wing, for generating a magnetic force to be restored by the restoring means.

7. The valve as claimed in claim 5, wherein the flow locking means includes a third fixing plate threaded into the inner wall of the valve case and being spaced apart at a constant distance from the rotary wing via a cylindrical body, a check valve-typed valve-body having a shielding member for shielding or opening a fluid flowing from the outlet port of the second fixing plate to a discharging port of the second plate, and a follower with a magnet for the follower secured to one end of thereof, wherein the shielding member has a cover coming and going to the outlet port via the supporting member, and a valve body magnet mounted onto one end of the supporting member, the supporting member has an outer end pivotally supported onto one side of the third fixing plate, and the follower has the other end secured to a center of the cover of the shielding member.

8. The valve as claimed in claim 5, wherein the restoring means includes an alternate magnetic force producing magnet reacting magnet secured to an outside of the valve case for reacting with the valve body magnet, a rotating body reacting magnet secured to the outside of the valve case for reacting with the rotating body magnet secured at a constant distance from the inlet port of the flow detecting means, an alternate magnetic force producing magnet for producing an alternate magnetic force to operate and restore the magnet of the check valve-typed valve body, and driving means for rotating the magnet by a half, with the magnet rotatably supported on the outside of the valve case.

9. The valve as claimed in claim 8, wherein the drviving means is an electric motor.

10. The valve as claimed in claim 8, wherein the driving means includes a rotating shaft rotatably supporting the magnet and intermittently securing the magnet, a rotation stopping plate secured onto one end of the rotating shaft, and a solenoid intermittently inserted into the offset hole formed on the plate.

11. The valve as claimed in claim 5, wherein the displacement detecting means includes a rotating body detecting sensor, secured to the outside of the valve case, for detecting the displacement of the magnet of the flow detecting means, and a follower detecting sensor, secured to the outside of the valve case, for detecting the displacement of the magnet of the flow detecting means.

12. The valve as claimed in claim 5, wherein the flow locking means includes a valve cock, engaged to a downstream end of the check valve-typed valve body, for shielding and opening the passage of the fluid, separate with the check valve-typed valve body.

13. The valve as claimed in claim 5 or 12, wherein the displacement detecting means includes a valve cock detecting sensor, secured to the outside of the valve case, for detecting the displacement of a valve cock magnet secured to a handle of the valve cock.

14. The valve as claimed in claim 5 or 11, wherein the displacement detecting means is a non-contact adjacent sensor.

15. The valve as claimed in claim 13, wherein the displacement detecting means is a non-contact adjacent sensor.

16. The valve as claimed in claim 7, wherein the shielding member of the check valve-typed valve body is floated between the follower secured to a center of the supporting member and a locking protrusion formed on an upper portion of the follower.

17. A restoring apparatus for auto valve having a valve case acting as a sealing means for sealing line connection means such as a pipe or hose for passing fluid therethrough, the valve device comprising:
flow detecting means, provided in the valve case, for acting as a flow sensor in response to a pressure according to a flow rate of the fluid to detect the flow of the fluid, the flow detecting means having a rotary wing for rotating by the pressure of the flowing fluid to open/close a passage; and
restoring means for producing an magnetic force to operate and restore the flow detecting means.

18. The restoring apparatus for auto valve as claimed in claim 17, further comprising a displacement detecting means for detecting rotation of the rotary wing of the flow detecting means.

19. The restoring apparatus for auto valve as claimed in claim 17 or 18, wherein the flow detecting means includes a first fixing plate concentrically arranged with an inner surface of the valve case and having an inlet port on one side thereof, a second fixing plate secured to the first fixing plate through a number of fixing columns and having an outlet port on the other side, a rotary wing rotatably supported around a shaft which is an imaginary line connecting a center of the first fixing plate and a center of the second fixing plate, and a rotary magnet, fixed on the rotary wing, for generating a magnetic force to be restored by the restoring means.

20. An restoring apparatus for auto valve having a valve case acting as a sealing means for sealing line connection me such as a pipe or hose for passing fluid therethrough, the valve device comprising:
flow locking means, provided in the valve case, for acting as a check valve-typed valve body in response to a pressure according to the flow of the fluid to control a flow rate of the fluid; and
restoring means for producing an alternate magnetic force to operate and restore the flow locking means and the check valve-typed valve body.

21. The restoring apparatus for auto valve as claimed in claim 20, further comprising a displacement detecting means for detecting rotation of the check valve-typed valve body of the flow locking means.

22. The restoring apparatus for auto valve as claimed in claim 20 or 21, further comprising an alternate magnetic force producing magnet, rotatably supported on an outside of the valve case, for producing an alternate magnetic force to operate and restore the magnet of the check valve-typed valve body, and driving means for rotating the magnet by a half, with the magnet rotatably supported on the outside of the valve case.

23. The restoring apparatus for auto valve as claimed in claim 20 or 22, further comprising an alternate magnetic force producing magnet reacting magnet, secured to the outside of the valve case, for reacting with the valve body magnet fixed on the check valve-typed valve body.
